(19) United States
(12) Patent Application Publication
(10) Pub. No.: US 2003/0108334 A1
(43) Pub. Date: Jun. 12, 2003

(54) Adaptive environment system and method of providing an adaptive environment

(75) Inventors: Dimitrova Nevenka, Yorktown Heights, NY (US); Zimmerman John, Ossining, NY (US); McGee Thomas, Garrision, NY (US); Jasinschi Radu, Ossining, NY (US)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECRONICS N.V.

(21) Appl. No.: 10/011,872

(22) Filed: Dec. 6, 2001

(51) Int. Cl. H04N 5/91

(52) U.S. Cl. 386/95

(57) ABSTRACT

An adaptive environment system comprises a recording device for recording a video which is analyzed by a processor and indexed according to features of the video. The video is segmented into at least visual, audio, and textual components, which can be analyzed by the processor. The processor then creates an index file of the features analyzed and stores the video along with the index file on a storage device. The video can then be search according to the index file and a portion of the video identified by the search returned to a display for viewing. In addition, the adaptive environment system may comprise a processing system connectable to a network wherein the network comprises one or more interconnected sensors. The processing system comprises a computer readable medium comprising computer code for instructing one or more processors to: (a) receive recorded data from the one or more sensors connectable to the processing system; (b) analyze the recorded data to identify an event occurring in the recorded data; (c) determine whether a response to the identified event is appropriate; and (d) when a response is appropriate generate a signal associated with the response.

### FIELD OF THE INVENTION

The present invention relates to the a system for providing an adaptive environment and, in particular, to a system for use in an environment to record, segment, and index video, audio, and other data captured by sensors in the environment.

### BACKGROUND OF THE INVENTION

As analog and digital recording of both audio and video have become mainstream, people are increasingly recording various events in their lives. Video/audio tapes, and more recently CDROMs, are a cumbersome means of storing and cataloging events. Oftentimes, tapes are lost or the label describing the contents becomes unreadable. Even when a tape is found, the user often has to fast forward through hours of video before finding the desired event. While it may be easier to store and identify individual files in digital form, generally available indexing systems are limited and do not adequately provide for the segmentation and indexing of events on a frame-by-frame basis.

Other systems for recording and indexing television programs, such as personal video recorders (PVRs) like TiVo®, use electronic program guide metadata to automatically select and store whole TV programs based on users' profiles. These systems can be limited, however, because such systems do not allow for the segmentation and indexing of events on a frame-by-frame basis.

Furthermore, events that take place in one's house or office may be missed (i.e., unrecorded) because there are no tapes or the camera is out of battery. For example, a child's first words or first steps could be missed because by the time the camera is ready the event has passed.

Home security and home monitoring systems are also known. Such systems use motion detectors, microphones, cameras, or other electronic sensors to detect the presence of someone when the system is armed. Other types of home monitoring systems employ a variety of sensors to monitor various home appliances, including furnaces, air conditioners, refrigerators, and the like. Such systems, however, are generally limited in their use due to the specialized nature of the sensors and the low processing power of the processors powering such systems. For instance, home alarms are routinely falsely set-off when a household member or the family dog strays into the sight of a motion detector.

Furthermore, current systems for denying access to certain home appliances, such as the television or personal computers attached to the Internet, are cumbersome and ineffective. For instance, some televisions can be programmed to require a password to access television programs of a certain rating. These systems, however, require that each member of a family use a PIN to identify themselves to the television. Oftentimes, such systems go unused because people find it unmanageable to use such systems.

Thus, a system that passively records data and provides for the segmentation and indexing of the data such that it is easily retrievable is desirable.

It is further desirable to have a home or office security system that could identify individuals and avoid false alarms. Moreover, it is desirable to use such a system to control access to household appliances such as televisions, Internet connections, personal computers, ovens, etc.

Yet further, it is desirable to provide for a system that can observe the behavior and habits of individuals and anticipate their actions. For example, a system that could control repetitive tasks such as controlling the heating, cooling, lighting, and other household and office conditions based upon an individual's preferences or past behavior is desirable.

### SUMMARY OF THE INVENTION

The present invention overcomes shortcomings found in the prior art. The present invention provides an integrated and passive adaptive environment that analyzes audio, visual, and other recorded data to identify various events and determine whether an action needs to be taken in response to the event. The analysis process generally comprises monitoring of an environment, segmentation of recorded data, identification of events, and indexing of the recorded data for archival purposes.

Generally speaking, one or more sensors monitor an environment and passively record the actions of subjects in the environment. The sensors are interconnected with a processing system via a network. The processing system is advantageously operative with a probabilistic engine to segment the recorded data. The segmented data can then be analyzed by the probabilistic engine to identify events and indexed and stored in a storage device, which is either integrated with or separated from the processing system. As will become evident from the following disclosure, the processing system according to the present invention can perform any number of functions using the probabilistic approach described herein.

In one embodiment of the invention, the processing system segments and indexes the recorded data so as to allow users to search for and request events that have occurred in the environment. For example, users can request particular events that have occurred in the operating environment, which are extracted from the stored data and replayed for the user. In addition, the system of the present invention monitors the repeated behavior of subjects in the environment to learn their habits. In further embodiment of the present invention, the system can remind the subject to perform a task or even perform that task for the subject.

The processing system is connectable to a network of sensors, which passively record events occurring in the environment. In an embodiment of the present invention, the sensors or recording devices may be video cameras capable of capturing both video and audio data or microphones. Preferably, the sensors are connected to a constant source of power in the operating environment so as to passively operate on a consistent basis. As the data is captured, it separates the video from the audio data captured by the cameras. These separated streams of data are then analyzed by a probabilistic engine of the processing system, which analyzes the streams of data to determine the proper segmentation and indexing of the data.

The probabilistic engine of the processor also enables the processor to track repetitive actions by the recorded subjects. The probabilistic engine can then select those activities that occur more frequently than other of the subject's activities. Thus, the probabilistic engine essentially learns the habits of the subjects it records and can begin to remind the subjects to perform tasks or perform tasks automatically.

In another embodiment, the system operates as a security system wherein the processing engine uses the captured data to identify individuals and provide or deny access to various components of the operating environment. Once an individual is identified, the processing engine can access a database of stored user access parameters. For instance, a young child may not be provided access to certain channels on the television. Thus the processor can automatically identify the young child and set a system in the television (such as a V-chip) to deny access to certain channels based upon this user information. Furthermore, the system can identify when unidentified individuals are present in the house and notify the proper authorities or set off an alarm.

In accordance with another aspect of the present invention, a method of retrieving recorded events, comprises collecting data from various recording devices, de-mixing the data into individual components, analyzing each component of the de-mixed data, segmenting the analyzed data into a plurality of components, indexing the segmented data according to a set of values collected by the processor, and retrieving the data from a storage device in response to a request from a user that includes an identifier of a portion of the indexed and segmented data.

The above and other features and advantages of the present invention will become readily apparent from the following detailed description thereof, which is to be read in connection with the accompanying drawings.

### BRIEF DESCRIPTION OF THE DRAWINGS

In the drawing figures, which are merely illustrative, and wherein like reference numerals depict like elements throughout the several views:

FIG. 1 is a schematic diagram of an overview of an exemplary embodiment of the system architecture in accordance with the present invention;

FIG. 2 is a flow diagram of an exemplary process of segmenting and classifying recorded data;

FIG. 3 is a schematic diagram of an exemplary embodiment of the segmentation of the video, audio, and transcript streams;

FIG. 4 is a flow diagram of an exemplary process of creating an index file for searching recorded data;

FIG. 5 is a schematic diagram of an exemplary process of retrieving indexed data; and

FIG. 6 is a flow diagram of an exemplary process of providing security to electronic devices connected to the system of the present invention.

### DETAILED DESCRIPTION OF THE PREFERRED EMBODIMENTS

The present invention provides an adaptive environment that comprises a passive event recording system that passively records events occurring in the environment, such as a house or office. The recording system uses one or more recording devices, such as video cameras or microphones. The system processes the recorded events to segment and index the events according to a set of parameters. Because the system is passive, people interacting with the system need not concern themselves with the operation of the system. Once the recorded data is segmented and indexed it is stored on a storage device so as to be easily retrievable by a user of the system.

The passive recording system according to the present invention preferably comprises one or more recording devices for capturing a data input and a processing engine communicatively connected to the recording devices. Once content is received from the recording devices, the processing engine segments the content according to a three-layered approach that uses various components of the content. The segmented content is then classified based on the various content components. The content is then stored on a storage device that is also interconnected to the processor via a network such as a local area network (LAN). The content can be retrieved by users by searching for objects that are identifiable in the content, such as searching for a “birthday and Steve”. In such an example, the processing engine would search for segments of the content fulfilling the search criteria. Once found the entire segments can be returned to the user for viewing.

The processing system preferably uses a Bayesian engine to analyze the data stream inputs. For example, preferably each frame of the video data is analyzed so as to allow for the segmentation of the video data. Such methods of video segmentation include but are not limited to cut detection, face detection, text detection, motion estimation/segmentation/detection, camera motion, and the like. Furthermore, the audio data is also analyzed. For example, audio segmentation includes but is not limited to speech to text conversion, audio effects and event detection, speaker identification, program identification, music classification, and dialogue detection based on speaker identification. Generally speaking, audio segmentation involves using low level audio features such as bandwidth, energy and pitch of the audio data input. The audio data input may then be further separated into various components, such as music and speech. Using these and other parameters, the system passively records and identifies various events that occur in the home or office and can index the events using information collected from the above processes. In this way, a user can easily retrieve individual events and sub events using plain language commands or the processing system can determine whether an action is necessary in response to the identified event. In operation, upon receipt of a retrieval request from a user, the processing engine calculates a probability of the occurrence of an event based upon the plain language commands and returns the requested event.

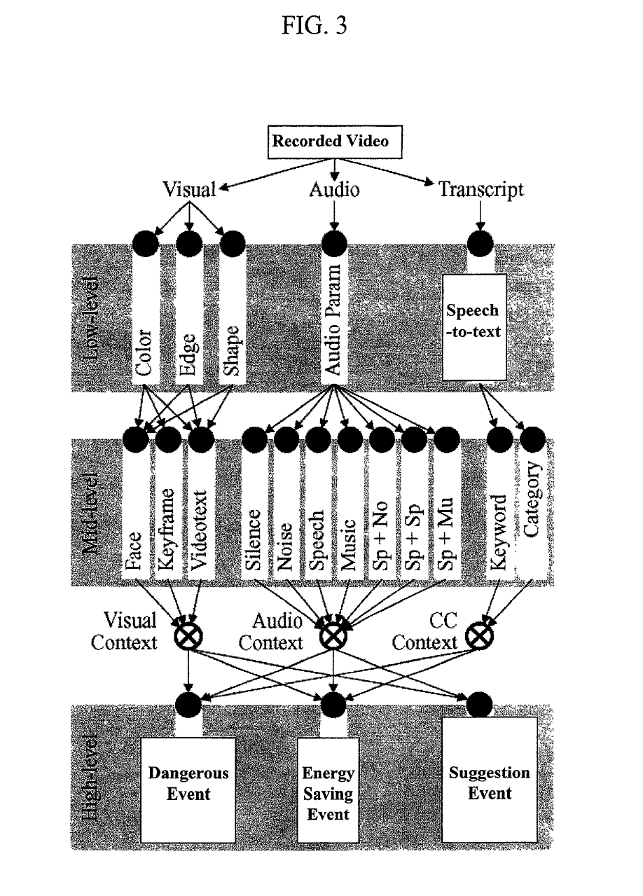

By way of example, as shown in FIG. 3, the probabilistic engine can identify dangerous events (such as burglaries, fires, injuries, etc.), energy saving events (such as opportunities to shut lights and other appliances off, lower the heat, etc.), and suggestion events (such as locking the doors at night or when people leave the environment).

It should be understood that although the present invention is described in connection with the passive recording system used in an operating environment, such as a home or office type environment, the passive recording system can be used in any operating environment in which a user wishes to record and index events occurring in that environment. That environment may be outdoors or indoors.

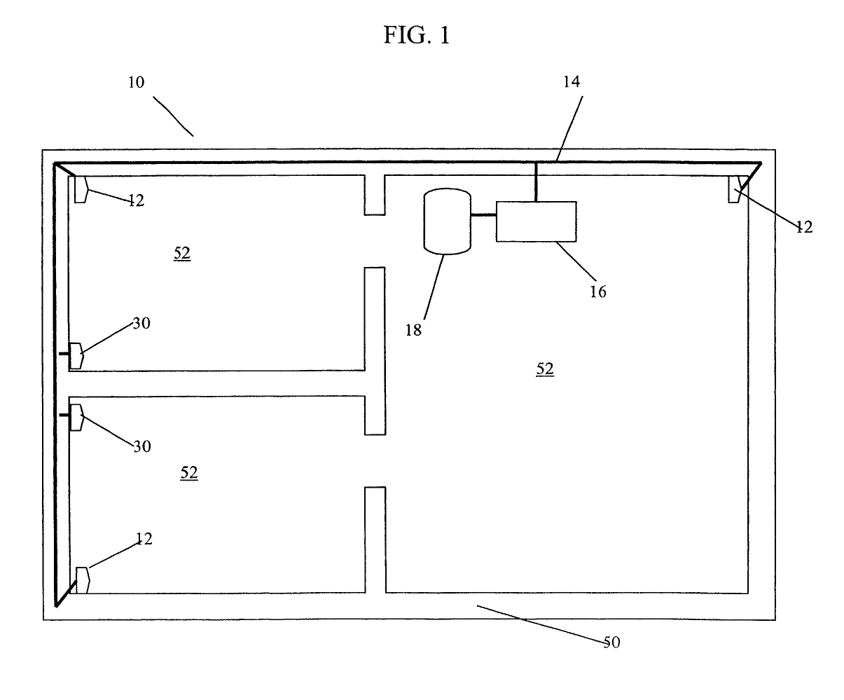

Refer now to FIG. 1, a system 10 according to the present invention is shown wired in a household environment 50. As can be seen, the house has many rooms 52 that may each have a separate recording device 12. Each recording device 12 is interconnected via a local area network (LAN) 14 to one another and to the processor 16. In turn, the processor 16 is interconnected to a storage device 18 for storing the collected data. A terminal for interacting with the processor 16 of the passive recording system 10 may also be present. In a preferred embodiment, each recording device 12 is wired to the house's power supply (not shown) so as to operate passively without interaction from the users. Thus, the recording system 10 operates passively to continuously record events occurring in the house without intervention or hassle by the users. Furthermore, one or more of the electronic systems (not shown) in the operating environment (e.g., appliances, televisions, heating and cooling units, etc.) may be interconnected to the LAN 14 so as to be controllable by the processor 16.

The processor 16 is preferably hosted in a computer system that can be programmed to perform the functions described herein. By way of example only, the computer system may comprise a processor and associated operating memory (RAM and ROM), and a processor, such as the Philips TriMedia™ Tricodec card for pre-processing the video, audio and text components of the data input. The processor 16, which may be, for example, an Intel Pentium chip or other multiprocessor, performs an analysis of frames of data captured by the recording devices to build and store an index in an index memory, such as, for example, a hard disk, file, tape, DVD, or other storage medium. The computer system is interconnected to and communicates with the storage device 18, recording devices 12, and other electronic components via a LAN 14, which is either hardwired throughout the operating environment or operates wirelessly.

Operatively coupled to the processor 16 is a storage device 18 (for example, RAM, hard disk recorder, optical storage device, or DVHS, each preferably having hundreds of giga-bytes of storage capability) for storing the recordings of the events. Of course, the processor 16 and storage device 18 can be integrated into a single unit.

The recording devices or sensors 12 may be video cameras having integrated microphones so as to receive both video and audio data. In other embodiments the recording devices 12 may be microphones, motion detectors or other types of sensors. The recording devices 12 may further be equipped to have motion detectors that enable the recording device 12 to fall into a sleep mode when no events are occurring in a particular room and awake upon the detection of movement or action in the room. In this way, power will be conserved and storage space in the storage device 18 is preserved. Yet further, the video cameras can include a pivoting system that allows the cameras to track events occurring in a particular room. In such a system, by way of example, a child that is walking from a bedroom can be followed out the door by a first camera, down the hallway by a second camera and into a play area by a third camera.

An exemplary method of tracking a subject in a multiple camera system is described in International Publication WO 00/08856 to Senugupta et al., the entire disclosure of which is incorporated herein by reference, and described in relevant part herein. The camera tracking system generally comprises two or more video cameras 12 (shown in FIG. 1). The cameras 12 may be adjustable, pan/tilt/zoom, cameras. The cameras 12 provide an input to a camera handoff system (not shown in the Figures); the connections between the cameras 12 and the camera handoff system may be direct or remote, for example, via a telephone connection or other network. The camera handoff system preferably includes a controller, a location determinator, and a field of view determinator. The controller effects the control of the cameras 12 based on inputs from various sensors, the location determinator and the field of view determinator.

The field of view determinator determines the field of view of each camera based upon its location and orientation. Non-adjustable cameras have a fixed field of view, whereas the adjustable cameras each have varying fields of view, depending upon the current pan, tilt, and zoom settings of the camera. Either type of camera may be used in accordance with the present invention. To facilitate the determination of each cameras field of view, the camera handoff system includes a database that describes the secured area and the location of each camera. The database may include a graphic representation of the secured area, for example, a floor plan as shown in FIG. 1. The floor plan is created and entered in the control system when the security system is installed, using for example Computer Aided Design (CAD) techniques well known to one skilled in the art. Each wall and obstruction is shown, as well as the location of each of the cameras 12.

The location determinator determines the location of an object within a selected camera's field of view. Based upon the object's location within the image from the selected camera, and the camera's physical location and orientation within the secured area, the location determinator determines the object's physical location within the secured area. The controller determines which cameras field of view include the object's physical location and selects the appropriate camera when the object traverses from one camera's field of view to another camera's field of view. The switching from one camera to another is termed a camera handoff.

In an exemplary embodiment, the camera handoff is further automated via the use of figure tracking system within the location determinator. The camera tracking system, upon detecting the figure of the person in the field of view of one of the cameras, identifies the figure to the figure tracking system, typically by outlining the figure on a copy of the image from camera on the video screen. Automated means can be employed to identify moving objects in an image that conform to a particular target profile, such as size, shape, speed, etc. The camera is initially adjusted to capture the figure, and the figure tracking techniques continually monitor and report the location of the figure in the image produced from camera. The figure tracking system associates the characteristics of the selected area, such as color combinations and patterns, to the identified figure, or target. Thereafter, the figure tracking system determines the subsequent location of this same characteristic pattern, corresponding to the movement of the identified target as it moves about the camera's field of view.

If the camera is adjustable, the controller adjusts the camera to maintain the target figure in the center of the image from the camera. That is, the camera's line of sight and actual field of view will be adjusted to continue to contain the figure as the person moves along path P I within the camera's potential field of view. Soon after the person progresses, the person will no longer be within the camera's potential field of view.

In accordance with this invention, based upon the determined location of the person and the determined field of view of each camera, the controller selects the next camera when the person enters the camera's potential field of view. In a preferred embodiment that includes a figure tracking system, the figure tracking techniques will subsequently be applied to continue to track the figure in the image from camera. Similarly, the system in accordance with this invention will select sequential cameras, as the person proceeds along a given path.

To effect this automatic selection of cameras, the camera handoff system includes a representation of each camera's location and potential field of view, relative to each other. For consistency, the camera locations are provided relative to the site plan of the secured area that is contained in the secured area database. Associated with each camera is a polygon or polyhedron, outlining each camera's potential field of view. A particular camera that has an adjustable field of view can view any area within a full 360 degree are, provided that it is not blocked by an obstruction. Camera with fixed fields of view may be limited to a specific view angle. The field of view polygon is also limited by such as the ability to see through passages in obstructions, Also associated with each camera is the location of the camera.

As discussed above, figure tracking processes are available that determine a figure's location within an image arid allows a camera control system to adjust the camera's line of sight so as to center the figure in the image. The controller will maintain an adjustable camera's actual line of sight, in terms of the physical site plan, for subsequent processing. If the camera is not adjustable, the line of sight from the camera to the figure is determined by the angular distance the figure is offset from the center of the image. By adjusting the camera to center the figure, a greater degree of accuracy can be achieved in resolving the actual line of sight to the figure. With either an adjustable or non adjustable camera, the direction of the target from the camera, in relation to the physical site plan, call thus be determined. For ease of understanding, the line of sight is used herein as the straight line between the camera and the target in the physical coordinate site plan, independent of whether the camera is adjusted to effect this line of sight.

To determine the precise location of the target along the line of sight, two alternative techniques can be employed: triangulation and ranging. In triangulation, if the target is along the line of sight of another camera, the intersection of the lines of sight will determine the target's actual location along these lines of sight. This triangulation method, however, requires that the target lie within the field of view of two or more cameras. Alternatively, with auto-focus techniques being readily available, the target's distance (range) from the camera can be determined by the setting of the focus adjustment to bring the target into focus. Because the distance of the focal point of the camera is directly correlated to the adjustment of the focus control on the camera, the amount of focus control applied to bring the target into focus will provide sufficient information to estimate the distance of the target from the location of the camera, provided that the correlation between focus control and focal distance is known. Any number of known techniques can be employed for modeling the correlation between focus control and focal distance. Alternatively, the camera itself may contain the ability to report the focal distance, directly, to the camera handoff system. Or, the focal distance information may be provided based upon independent means, such as radar or sonar ranging means associated with each camera.

In the preferred embodiment, the correlation between focus control and focal distance is modeled as a polynomial, associating the angular rotation x of the focus control to the focal distance R as follows:

R=a₀+a₁x+a₂x+ . . . +aₙxⁿ

The degree n of the polynomial determines the overall accuracy of the range estimate. In a relatively simple system, a two degree polynomial (n=2) will be sufficient; in the preferred embodiment, a four degree polynomial (n=4) is found to provide highly accurate results. The coefficients aₒ through aₙ are determined empirically. At least n+1 measurements are taken, adjusting the focus x of the camera to focus upon an item place at each of n+1 distances from the camera. Conventional least squares curve fitting techniques are applied to this set of measurements to determine the coefficients aₒ through aₙ. These measurements and curve fitting techniques can be applied to each camera, to determine the particular polynomial coefficients for each camera; or, a single set of polynomial coefficients can be applied to all cameras having the same auto-focus mechanism. In a preferred embodiment, the common single set of coefficients are provided as the default parameters for each camera, with a capability of subsequently modifying these coefficients via camera specific measurements, as required.

If the camera is not adjustable, or fixed focus, alternative techniques can also be employed to estimate the range of the target from the camera. For example, if the target to be tracked can be expected to be of a given average physical size, the size of the figure of the target in the image can be used to estimate the distance, using the conventional square law correlation between image size and distance. Similarly, if the camera's line of sight is set atan angle to the surface of the secured area, the vertical location of the figure in the displayed image will be correlated to the distance from the camera. These and other techniques are well known in the art for estimating an object's distance, or range, from a camera.

Given the estimated distance from the camera, and the camera's position and line of sight, the target location, in the site plan coordinate system, corresponding to the figure location in the displayed image from the camera, can be determined. Given the target location, the cameras within whose fields of view the location lies can be determined. This is because the cameras' fields of view are modeled in this same coordinate system. Additionally, the cameras whose fields of view are in proximity to the location can also tie determined.

At option, each of the cameras including the target point can be automatically adjusted to center the target point in their respective fields of view, independent of whether the camera is selected as the camera utilized for figure tracking. In the preferred embodiment, all cameras which contain the target in their potential field of view, and which are not allocated to a higher priority task, are automatically redirected to contain the target in their actual field of view.

Note that while automated figure tracking software is utilized in the preferred embodiment, the techniques presented herein are also applicable to a manual figure tracking scenario as well. That is, for example, the operator points to a figure in the image from a camera, and the system determines the line of sight and range as discussed above. Thereafter, knowing the target location, the system displays the same target location from the other cameras, automatically. Such a manual technique would be useful, for example, for managing multiple cameras in a sports event, such that the operator points to a particular player, and the other cameras having this player in their field of view are identified for alternative selection and/or redirection to also include this player.

A variety of techniques may be employed to determine whether to select a different camera from the one currently selected for figure tracking, as well as techniques to select among multiple cameras. Selection can be maintained with the camera containing the figure until the figure tracking system reports that the figure is no longer within the view of that camera; at that time, one of the cameras which had been determined to have contained the target in its prior location can be selected. The camera will be positioned to this location and the figure tracking system will be directed to locate the figure in the image from this camera. The assumption in this scenario is that the cameras are arranged to have overlapping fields of view, and the edges of these fields of view are not coincident, such that the target cannot exit the field of view of two cameras simultaneously.

In a preferred system, rather than utilizing the prior location, the camera handoff system includes an predictor that estimates a next location, based upon the motion (sequence of prior locations) of the figure. A linear model can be used, wherein the next location is equal to the prior location plus the vector distance the target traveled from its next-prior location. A non-linear model can be used, wherein the next location is dependent upon multiple prior locations, so as to model both velocity and acceleration. Typically, the figure tracking system locations exhibit jitter, or sporadic deviations, because the movement of a figure such as a person, comprising arbitrarily moving appendages and relatively unsharp edges, is difficult to determine absolutely. Data smoothing techniques can be applied so as to minimize the jitter in the predictive location, whether determined using a linear or non-linear model. These and other techniques of motion estimation and location prediction are well known to those skilled in the art.

Given a predicted location, in the site map coordinate system, the cameras containing the point within their potential fields of view can be determined. If the predicted location lies outside the limits of the current camera's potential field of view, an alternative camera, containing location in its field of view, is selected and adjusted so as to provide the target in its actual field of view. The system need not wait until the predicted location is no longer within the current camera's field of view; if the predicted location is approaching the bounds of the selected camera's field of view, but well within the bounds of another camera's field of view, the other camera can be selected. Similarly, the distance from each camera can be utilized in this selection process. As is common in the art, a weighting factor can be associated with each of the parameters associated with the viewing of a security scene, such as the distance from the camera, the distance from the edge of the camera field of view, the likelihood that the target will be locatable in the camera's field of view (influenced, for example, by the complexity of image from one camera versus that from another), whether this camera Is currently selected, etc. Using these weighting factors, the preference for selecting the camera can be determined, and the most preferred camera can be selected and adjusted.

Hereinafter, without loss of generality, target location will be used to identify the location to which a camera is intended to be directed, regardless of whether this location is the prior location or estimated next location.

If another camera cannot be found which contains the location, a camera with a field of view in the proximity of the location can be selected, and the figure tracking system directed to attempt to locate the figure in the subsequent images from this camera. To optimize the likelihood of success in selecting a camera that contains the figure, a variety of techniques can be employed. Each camera can contain a list of those cameras having a potential field of view in proximity to its potential field of view. This list would exclude Cameras whose fields of view are in proximity to its field of view, but which fields of views are physically separated and inaccessible from its field of view; for example a camera in an adjacent room, to which there is no access from this camera's room. Similarly, the list could be segregated by sub-areas within the camera's field of view, so as to include only those cameras having fields of view with direct access from each of the sub areas within the camera's field of view.

In addition to explicit list and sorting techniques, common to those skilled in the art, Expert System approaches to the identification and selection of subsequent actions can be employed. For example, given that the target is within a particular area in the site plan, the egresses from the area can be determined from the site plan, and the most likely egress identified based upon the pattern of activity of the target, or upon a model of likelihood factors associated with each egress point. For example, the route from the lobby of a bank to the bank's vault would have a high likelihood of use when the target first enters a bank. The bank exit would have a low likelihood of intended use at this time. But, these likelihood's would reverse once the target returns from the vault.

Hereinafter, a method of associating the position of a figure in an image, as reported by a figure tracking system, to the location of a target in the physical site plan coordinate system, will be described, as well as a method of selecting a camera whose field of view contains this target location.

The position of the figure within an image, and an identification of the camera providing this image, is provided by the figure tracking system and controller. The position of the image relative to the orientation of the camera determines the line of sight from the camera to the target, in the physical coordinate space. The orientation of the camera, in the physical coordinate space, is determined when the camera is initially installed. If the camera is not adjustable, the direction the camera is aimed, in the physical domain, is the orientation of the camera. If the camera is adjustable, the initial orientation is determined by aiming the camera at a point having a known location in the physical representation of the secured site, such as a comer; subsequent rotations of the camera will then be relative to this known direction.

To determine the location of the target along the determined line of sight, either ranging or interpolation methods may be employed if the range method is used, the distance between the camera and the target is determined using the methods discussed above. The target location, in the physical domain, is determined as the point along the line of sight at a distance from the camera's location.

If a triangulation method is utilized, the line of sight is stored and another image is assessed by the target tracking system to provide a position relative to another camera's image. The line of sight relative to this second camera is determined. The target location, in the physical domain, is determined at as the point at the intersection of the line of sight from the first camera's location and the line of sight from the second camera's location.

As discussed above, in the preferred embodiment, this target location is processed so as to produce a predicted next position, or filtered to remove jitter, or a combination of both. The processed target location is returned for presentation to the camera selection process. The following part of the description describes a method of identifying and selecting a camera containing the target point. Given the target point, in the physical domain coordinate system the camera handoff system in accordance with this invention determines which cameras contain this target point. Because each camera's potential field of view is represented as vertices in the physical domain coordinate system, the process merely comprises a determination of whether point lies within the polygon or polyhedron associated with each camera. If the number of cameras is large, this search process can be optimized, as discussed above. The search process employed would replace this exhaustive search loop.

The system thereafter selects one of the cameras containing the target point P in its potential field of view. As discussed above, a variety of techniques may be employed to select from among a number of cameras, typically with the current camera being given selection preference, to avoid a continual change of cameras and views. If no camera contains target point, the aforementioned predictive techniques can be applied to identify a new target point; alternatively, the closest camera to the target point can be selected. Once a camera is selected, its actual field of view is adjusted so as to contain the target point at the center of its image. Any changes in camera selection or orientation are communicated to the figure tracking system and the process returns.

In a further embodiment, the system comprises alarms, each alarm having an associated camera and predefined target point, in the physical domain coordinate system. Upon receipt of an alarm the system marks the associated camera for selection. The target point is set to the associated predefined target point and the process continues, as discussed above. Optionally, the system could signal the figure tracking system that a new target is to be identified, by noting movements in proximity to this target point in subsequent images; or, the operator, having been altered to the alarm and presented the image at the target point, could outline the figure directly. Thereafter, the system will track the figure, selecting alternate cameras to maintain the tracking, as discussed above.

Each camera would pivot to follow the child's movements and then turn off when the movement ceased to occur for a preset time period in that particular room. The now active camera would then detect the motion of the child entering the area and begin recording. This tracking feature of the recording devices 12 will be further described below in connection with an embodiment of the invention involving a content distribution system.

The environment 50 also preferably includes an integrated speaker or monitor system 30 interconnected with the LAN 14. As will be described further below, the monitor/speaker system 30 can be used to broadcast content to users of the system 10, such as TV, video, audio, or even voice reminders.

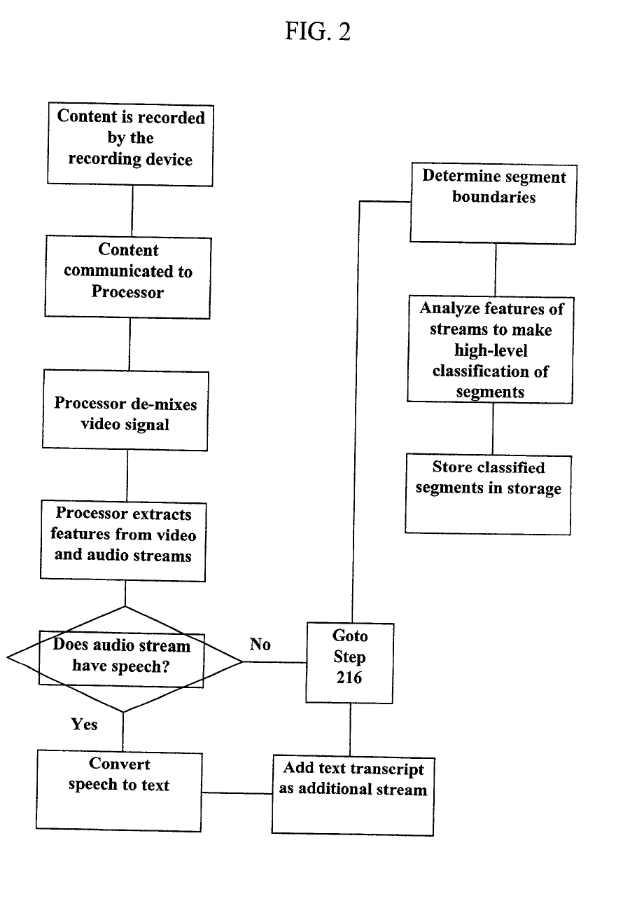

With reference to FIG. 2, an overview of the process of capturing, analyzing, segmenting, and archiving the content for retrieval by the user. When the recording devices are activated, video content is captured by the recording devices and transmitted to the processor, in steps 202 and 204. The processor receives the video content as it is transmitted and de-multiplexes the video signal to separate the signal into its video and audio components, in step 206. Various features are then extracted from the video and audio streams by the processor, in step 208.

As shown in FIG. 3, the features of the video and audio streams are preferably extracted and organized into three consecutive layers: low A, mid B and high C level. Each layer has nodes with associated probabilities. Arrows between the nodes indicate a causal relationship. The low-level layer A generally describes signal-processing parameters. In an exemplary embodiment the parameters include but are not limited to: the visual features, such as color, edge, and shape; audio parameters such as average energy, bandwidth, pitch, mel-frequency cepstral coefficients, linear prediction coding coefficients, and zero-crossings. The processor then preferably combines the low-level features to create the mid-level features. The mid-level features B are preferably associated with whole frames or collections of frames while low-level features A are associated with pixels or short time intervals. Keyframes (first frame of a shot, or a frame that is judged important), faces, and videotext are examples of mid-level visual features; silence, noise, speech, music, speech plus noise, speech plus speech, and speech plus music are examples of mid-level audio features; and keywords of the transcript along with associated categories make up the mid-level transcript features. High-level features C describe semantic video content obtained through the integration of mid-level features across the different domains. In other words, the high level features represent the classification of segments according to user or manufacturer defined profiles, described further below.

With reference again to FIG. 2, the processor attempts to detect whether the audio stream contains speech, in step 210. An exemplary method of detecting speech in the audio stream is described below. If speech is detected, then the processor converts the speech to text to create a time-stamped transcript of the recorded content, in step 212. The processor then adds the text transcript as an additional stream to be analyzed (see FIG. 3), in step 214.

Whether speech is detected or not the processor then attempts to determine segment boundaries, i.e., the beginning or end of a classifiable event, in step 216. In a preferred embodiment, the processor performs significant scene change detection first by extracting a new keyframe when it detects a significant difference between sequential I-frames of a group of pictures. As noted above, the frame grabbing and keyframe extracting can also be performed at pre-determined intervals. The video pre-processing module of the processing engine employs a DCT based implementations for frame differencing using cumulative macroblock difference measure. Alternatively, a histogram based method may be employed. We should note here that video material from home video cameras and surveillance cameras is quite different than broadcast video and some of the methods for keyframe extraction applied on broadcast video would not be effective in the home area. However, any method that can detect a significant difference between subsequent frames and help in extraction of important i.e. keyframes can be employed in the system. Unicolor keyframes or frames that appear similar to previously extracted keyframes get filtered out using a one-byte frame signature. The processing engine bases this probability on the relative amount above the threshold using the differences between the sequential I-frames.

A method of frame filtering is described in U.S. Pat. No. 6,125,229 to Dimitrova et al. the entire disclosure of which is incorporated herein by reference, and briefly described below. Generally speaking the processor receives content and formats the video signals into frames representing pixel data (frame grabbing). It should be noted that the process of grabbing and analyzing frames is preferably performed at pre-defined intervals for each recording device. For instance, when a recording device begins recording data, keyframes can be grabbed every 30 seconds. In this way, the processing engine can perform a Bayesian probability analysis, described further below, to categorize an event and create an index of the recorded data.

Once these frames are grabbed every selected keyframe is analyzed. Video segmentation is known in the art and is generally explained in the publications entitled, N. Dimitrova, T. McGee, L. Agnihotri, S. Dagtas, and R. Jasinschi, “On Selective Video Content Analysis and Filtering,” presented at SPIE Conference on Image and Video Databases, San Jose, 2000; and “Text, Speech, and Vision For Video Segmentation: The Infomedia Project” by A. Hauptmann and M. Smith, AAAI Fall 1995 Symposium on Computational Models for Integrating Language and Vision 1995, the entire disclosures of which are incorporated herein by reference. Any segment of the video portion of the recorded data including visual (e.g., a face) and/or text information relating to a person captured by the recording devices will indicate that the data relates to that particular individual and, thus, may be indexed according to such segments. As known in the art, video segmentation includes, but is not limited to:

Significant scene change detection: wherein consecutive video frames are compared to identify abrupt scene changes (hard cuts) or soft transitions (dissolve, fade-in and fade-out). An explanation of significant scene change detection is provided in the publication by N. Dimitrova, T. McGee, H. Elenbaas, entitled “Video Keyframe Extraction and Filtering: A Keyframe is Not a Keyframe to Everyone”, Proc. ACM Conf. on Knowledge and Information Management, pp. 113-120, 1997, the entire disclosure of which is incorporated herein by reference.

Face detection: wherein regions of each of the video frames are identified which contain skin-tone and which correspond to oval-like shapes. In the preferred embodiment, once a face image is identified, the image is compared to a database of known facial images stored in the memory to determine whether the facial image shown in the video frame corresponds to the user's viewing preference. An explanation of face detection is provided in the publication by Gang Wei and Ishwar K. Sethi, entitled “Face Detection for Image Annotation”, Pattern Recognition Letters, Vol. 20, No. 11, November 1999, the entire disclosure of which is incorporated herein by reference.

Motion Estimation/Segmentation/Detection: wherein moving objects are determined in video sequences and the trajectory of the moving object is analyzed. In order to determine the movement of objects in video sequences, known operations such as optical flow estimation, motion compensation and motion segmentation are preferably employed. An explanation of motion estimation/segmentation/detection is provided in the publication by Patrick Bouthemy and Francois Edouard, entitled “Motion Segmentation and Qualitative Dynamic Scene Analysis from an Image Sequence”, International Journal of Computer Vision, Vol. 10, No. 2, pp. 157-182, April 1993, the entire disclosure of which is incorporated herein by reference.

The method also includes segmentation of the audio portion of the video signal (Step 120) wherein the audio portion of the video is monitored for the occurrence of words/sounds that are relevant to the viewing preferences. Audio segmentation includes the following types of analysis of video programs: speech-to-text conversion, audio effects and event detection, speaker identification, program identification, music classification, and dialog detection based on speaker identification.

Audio segmentation includes division of the audio signal into speech and non-speech portions. The first step in audio segmentation involves segment classification using low-level audio features such as bandwidth, energy and pitch. Channel separation is employed to separate simultaneously occurring audio components from each other (such as music and speech) such that each can be independently analyzed. Thereafter, the audio portion of the video (or audio) input is processed in different ways such as speech-to-text conversion, audio effects and events detection, and speaker identification. Audio segmentation is known in the art and is generally explained in the publication by E. Wold and T. Blum entitled “Content-Based Classification, Search, and Retrieval of Audio”, IEEE Multimedia, pp. 27-36, Fall 1996, the entire disclosure of which is incorporated herein by reference.

Speech-to-text conversion (known in the art, see for example, the publication by P. Beyerlein, X. Aubert, R. Haeb-Umbach, D. Klakow, M. Ulrich, A. Wendemuth and P. Wilcox, entitled “Automaic Transcription of English Broadcast News”, DARPA Broadcast News Transcription and Understanding Workshop, VA, Feb. 8-11, 1998, the entire disclosure of which is incorporated herein by reference) can be employed once the speech segments of the audio portion of the video signal are identified or isolated from background noise or music. The speech-to-text conversion can be used for applications such as keyword spotting with respect to event retrieval.

Audio effects can be used for detecting events (known in the art, see for example the publication by T. Blum, D. Keislar, J. Wheaton, and E. Wold, entitled “Audio Databases with Content-Based Retrieval”, Intelligent Multimedia Information Retrieval, AAAI Press, Menlo Park, Calif., pp. 113-135, 1997, the entire disclosure of which is incorporated herein by reference). Events can be detected by identifying the sounds that may be associated with specific events. For example, the singing of “Happy Birthday” could be detected and the segment could then be indexed in memory as a birthday event.

Speaker identification (known in the art, see for example, the publication by Nilesh V. Patel and Ishwar K. Sethi, entitled “Video Classification Using Speaker Identification”, IS&T SPIE Proceedings: Storage and Retrieval for Image and Video Databases V, pp. 218-225, San Jose, Calif., February 1997, the entire disclosure of which is incorporated herein by reference) involves analyzing the voice signature of speech present in the audio signal to determine the identity of the person speaking. Speaker identification can be used, for example, to search for a particular family member.

Event identification involves analyzing the audio portion of the data signal captured by the recording devices to identify and classify an event. This is especially useful in cataloging and indexing of events. The analyzed audio portion is compared to a library of event characteristics to determine if the event coincides with known characteristics for a particular event.

Music classification involves analyzing the non-speech portion of the audio signal to determine the type of music (classical, rock, jazz, etc.) present. This is accomplished by analyzing, for example, the frequency, pitch, timbre, sound and melody of the non-speech portion of the audio signal and comparing the results of the analysis with known characteristics of specific types of music. Music classification is known in the art and explained generally in the publication entitled “Towards Music Understanding Without Separation: Segmenting Music With Correlogram Comodulation” by Eric D. Scheirer, 1999 IEEE Workshop on Applications of Signal Processing to Audio and Acoustics, New Paltz, N.Y. Oct. 17-20, 1999.

The various components of the video, audio, and transcript text are then analyzed according to a high level table of known cues for various event types, in step 218. Each category of event preferably has knowledge tree that is an association table of keywords and categories. These cues may be set by the user in a user profile or pre-determined by a manufacturer. For instance, the “graduation” tree might include keywords such as school, graduation, cap, gown, etc. In another example, a “birthday” event can be associated with visual segments, such as birthday candles, many faces, audio segments, such as the song “Happy Birthday”, and text segments, such as the word “birthday”. After a statistical processing, which is described below in further detail, the processor performs categorization using category vote histograms. By way of example, if a word in the text file matches a knowledge base keyword, then the corresponding category gets a vote. The probability, for each category, is given by the ratio between the total number of votes per keyword and the total number of votes for a text segment.

In a preferred embodiment, the various components of the segmented audio, video, and text segments are integrated to index an event. Integration of the segmented audio, video, and text signals is preferred for complex indexing. For example, if the user desires to retrieve a speech given during someone's birthday, not only is face recognition required (to identify the actor) but also speaker identification (to ensure the actor on the screen is speaking), speech to text conversion (to ensure the actor speaks the appropriate words) and motion estimationsegmentation-detection (to recognize the specified movements of the actor). Thus, an integrated approach to indexing is preferred and yields better results.

In step 220, this segment information is then stored along with the video content on a storage device connected to the processor.

A preferred process of generating the high level inferences of the high-level layer will now be described. Preferably, a Bayesian probabilistic analysis approach is used because such approach integrates either intra or inter-modalities. Intra-modality integration refers to integration of features within a single domain. For example: integration of color, edge, and shape information for videotext represents intra-modality integration because it all takes place in the visual domain. Integration of mid-level audio categories with the visual categories face and videotext offers an example of inter-modalities because it combines both visual and audio information to make inferences about the content. A probabilistic approach to this integration is found in Bayesian networks. They allow the combination of hierarchical information across multiple domains and handle uncertainty. Bayesian networks are directed acyclical graphs (DAG) in which the nodes correspond to (stochastic) variables. The arcs describe a direct causal relationship between the linked variables. The strength of these links is given by conditional probability distributions (cpds). More formally, let the set Ω(x₁, . . . x_{N}) of N variables define a DAG. For each variable there exists a sub-set of variables of Ω, Πₓᵢ, the parents set of xᵢ, i.e., the predecessors of xᵢ in the DAG, such that P(xᵢ|Πₓᵢ)=P(xᵢ|xᵢ, . . . xᵢ₋₁), where P(•|•) is a cpd, strictly positive. Now, given the joint probability density function (pdf) P(xᵢ, . . . , x_{N}), using the chain rule, we get that P(xᵢ, . . . , x_{N})=P(x_{N}|x_{N-1}, . . . x₁)* . . . *P(x₂|x₁)P(x₁). According to this equation, the parent set Πₓᵢ has the property that xᵢ and {xᵢ, . . . , x_{N}}\Πₓᵢ are conditionally independent given Πₓᵢ.

As previously described the structure of a DAG is preferably made up of three layers. In each layer, each element corresponds to a node in the DAG. The directed arcs join one node in a given layer with one or more nodes of the preceding layer. Two sets of arcs join the elements of the three layers. For a given layer and for a given element, a joint pdf is calculated as previously described. There can exist an overlap between the different parent sets for each level.

Topic segmentation and classification performed by the processor as shown in the third layer (high-level C) of FIG. 3. In a preferred embodiment, the processor performs indexing of content according to the users' or a manufacturer's predefined high-level keyword table. The processor indexes the content by (i) reading keywords and other data from the high-level table and (ii) classifying the content into segments based on several high-level categories.

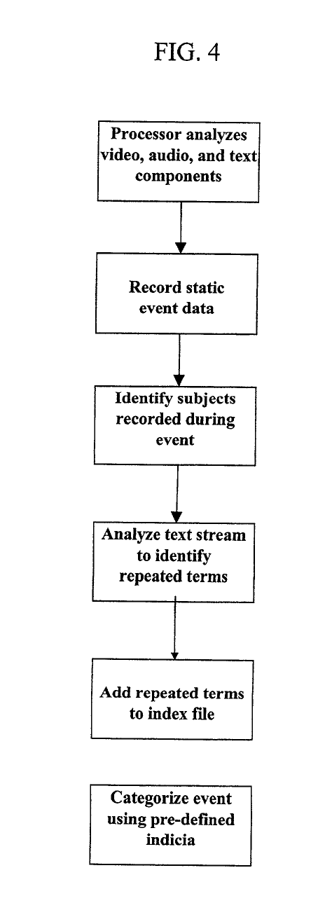

Thus, with reference to FIG. 4, there is shown an exemplary analysis of a conversation between two members of a household according to the present invention. Once the content is segmented and analyzed according a preferred embodiment, described above, a Bayesian approach or other probabilistic analysis approach may be used to create an index file for the segmented content. As can be seen, one method of indexing the event takes into account the appearance of visual, audio, and textual indicia of a particular event.

In this analysis, the processor determines the probability of an event that an event fits into a category, which, as described above, includes a number of indicia of that category. The processor may additionally identify those subjects appearing in the visual segments using a face detection method. This information is stored in the index file and provides link to the segmented content, which can be search by a user.

By way of example only, with reference to FIG. 4, a conversation in the kitchen involving Bob and Mary regarding a certain stock “XYZ Corp.” can be indexed as follows. In steps 402 and 404, the processor, after analyzing the various video, audio, and textual components, would record certain static data about the event. For instance, the date and time of the event and the room in which the event was captured would be stored in the index file, as shown in FIG. 4. Furthermore, the processor preferably uses a combination of the face detection segment of the video stream, along with a voice recognition segment of the audio stream to identify the subjects (Bob and Mary) associated with the event, in step 406. In steps 408 and 410, the processor would also categorize the event according to the textual terms that were repeated more than a certain number of times during the event. For example, an analysis of the text transcript would identify that the terms “XYZ Corp.”, “stock”, and “money” were repeatedly spoken by the subjects and, thus would be added to the index file. Moreover, the processor would use a probabilistic approach to determine the nature of the event, i.e., a conversation, in step 412. This is preferably performed by using predefined indicia of a conversation, including but not limited to the noise level and speech characteristics of the audio stream, the repeated changing of speakers in the text stream, and the limited movement of the subjects in the video stream.

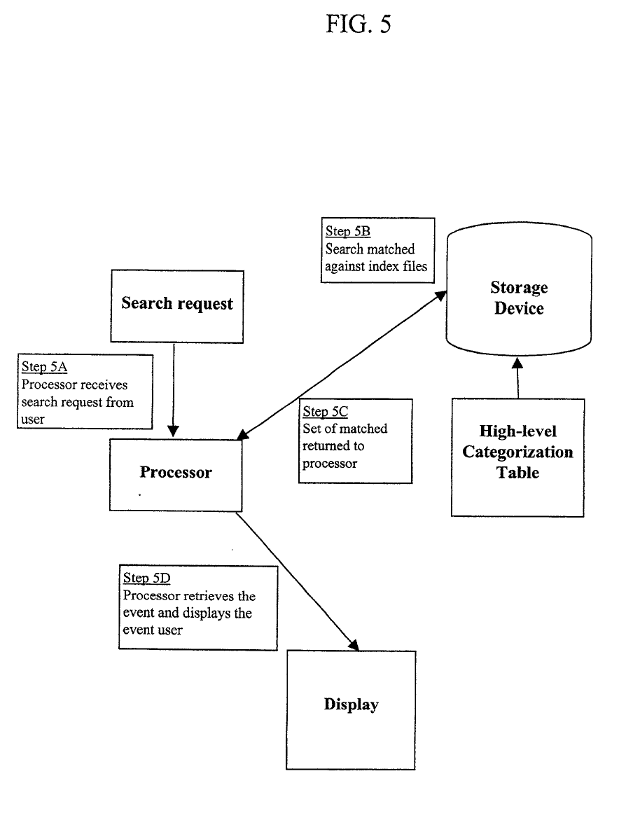

With further reference to FIG. 5, an exemplary process of retrieving Bob and Mary's conversation. As noted above, the processor 516 is programmed with functionality to display an interface through which a user can input a search request for a particular event. The processor 516 is also connected to a display device 517 which may be a CRT monitor, television, or other display device. The processor 516 would receive the search request, which might include the following terms in a known Boolean structure: “Bob AND Mary AND Kitchen AND stock”, in step 5A. These terms would then be matched against the index files stored in the storage device 518 to find the index files that best match the request criteria, in step 5B. Once a match or set of matches is returned to the user, the user can select one of the events identified to be returned to the display, in step 5C. In step 5D, the processor then retrieves the event and plays it on the display.

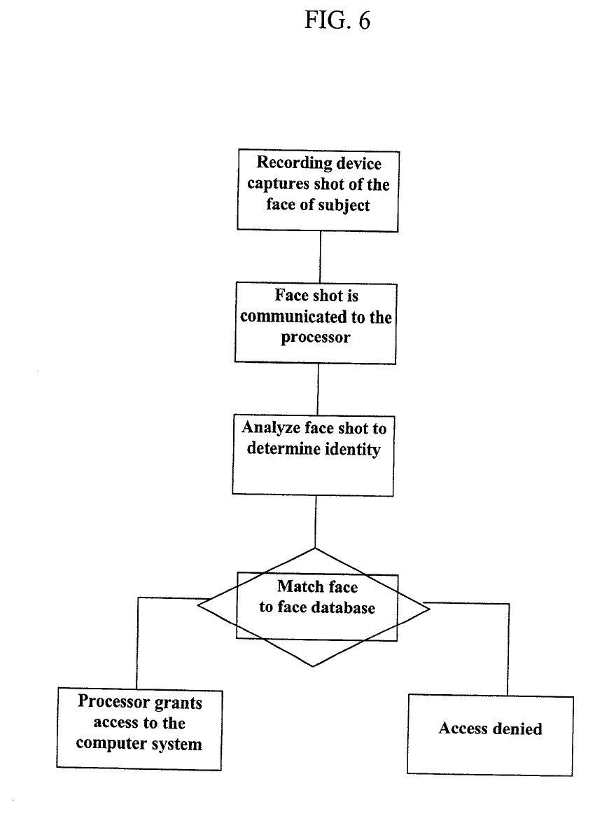

In an alternate embodiment, the video segments of the data are used to identify persons captured by the recording devices in real-time. With reference to FIG. 6, a flow diagram of a process for controlling and providing or denying access to various home appliances is shown. In this embodiment, the network is interconnected to various home appliances, as shown in FIG. 1, and the processor is programmed to interact with microprocessors installed in the appliances.

Although the following process is described in connection with the use of a home computer, it is to be understood that one skilled in the art could provide similar functionality for any of the appliances commonly found in the home or office. For the purpose of this example, it is assumed that a recording device (e.g., a video camera) is positioned so as to record the face of the subject trying to the access the appliance. In step 602, the recording device captures a shot of the face of the subject. The shot is then passed to the processing engine in step 604. In step 606, the processing engine uses a face detection technique to analyzed and determine the identity of the individual. To improve the accuracy of the system, a voice recognition technique as earlier described may also be used in combination with the face detection technique. If the individual's face matches one of the faces for which access is to be granted, then the processing engine grants access to the computer system, in step 608A. If not, then access is denied, in step 608B. As such, the individual's face acts as a login or password. Alternatively, where the recording device is a microphone or other audio capture device, a voice recognition system could be used to identify an individual and provide or deny access. Such a system would operate substantially as described above.

With reference back to FIG. 1, according to an embodiment of the present invention, the recording system 10 can constantly record the actions of subjects in the environment 24 hours a day, 7 days a week. In any given day, for example, the recording system 10 may record and identify any number of events or individual actions performed by a particular subject. By identifying the actions, the probabilistic engine can identify those actions which happen repetitively throughout the day or at similar times from day to day. For instance, each night before the subjects go to bed, they may lock the front and back doors of the environment. After several times, the probabilistic engine will identify that this action is performed at night on each day. Thus, the processing system 16 can be programmed to respond to the identified actions in any number of ways, including reminding the subjects to perform the task or actually performing the task for the subjects. By way of non-limiting example, the processing system 16 can be connected to and programmed to operate the electrical systems of the house. Thus, the processing system 16 can turn off the lights when all of the subjects go to bed at night.

In yet another embodiment, the recording device 12, such as a video camera, can be positioned at the front door of the environment 50 to record subjects that approach the door. The recording device 12 can take a snapshot of person(s) visiting the environment and then notify the owner of the environment that a particular person stopped by. This may be done by sending an e-mail to the user at work or storing the snapshot image for later retrieval by the user. The recording device 12 at the front door can also identify a dangerous event when a child member of the environment 50 returns home at an unusual time. For instance, when a child comes home sick from school early, the recording device 12 can record the time and an image of the child returning home so that a parent can be notified of this unusual (and potential dangerous) event. Again, the snapshot and time stamp can be e-mailed to the parent or communicated in any other way using mobile devices, such as wireless phones or PDAs.

As mentioned earlier, the system can also be used to broadcast content throughout the environment. For instance, a user may wish to listen to an audio book without having to carry a cassette player and headphones with them wherever they travel within the environment. Thus, the sensors or recording devices 12 of the recording system 10 can broadcast the audio book through the speakers interconnected with the system in a particular room in which the subject is located. As the subject moves about the environment, the broadcast audio signal can be sent to those speakers that are in close proximity to the subject. By way of example, if the subject is in the kitchen cooking dinner, the speakers in the kitchen would be active. When the subject moved from the kitchen to the dinning room to eat dinner, the speakers in the dinning room would be activated.

In yet another embodiment, the passive recording system can be used as a monitoring or security system. In such a system, the recording devices are preferably equipped with motion detectors to detect motion and to begin recording upon the appearance of a subject in the field of view of the recording device. If the system is armed and motion is detected, the recording device would record a shot of the subject's face. Then, using a face detection technique, the subject's face could be matched against a database that contains the faces of the individuals that live in the home or work at the office. If a match is not made, then an alarm can be setoff or the proper authorities notified of a possible intrusion. Because the system of the present invention combines both motion detection and face detection, the system is less likely to be falsely setoff by the family dog or other non-intrusive movement.

While the invention has been described in connection with preferred embodiments, it will be understood that modifications thereof within the principles outlined above will be evident to those skilled in the art and thus, the invention is not limited to the preferred embodiments but is intended to encompass such modifications.

We claim:

1. A method of passively recording and indexing events in an operating environment having at least one recording device connected to a network, the network being interconnected to a processor and a storage device, the method comprising:
recording video captured by the recording device;
segmenting the video into at least a video segment and an audio segment;
analyzing the video and audio segments to determine characteristics of the video;
categorizing a portion of the video according to predefined indicia;
associating the characteristics with the analyzed portion of the video; and
storing the video along with the associated category and characteristics on the storage device.

2. The method of claim 1, wherein the segmenting of the video further comprises generating a text transcript of the video.

3. The method of claim 2, further comprising analyzing the text transcript to determine whether a term is used repeatedly.

4. The method of claim 3, wherein the associating further comprises associating the terms used repeatedly with the video.

5. The method of claim 1, wherein a plurality of recording devices are connected to the network.

6. The method of claim 1, wherein the recording device is a video camera.

7. The method of claim 1, wherein the characteristics of the video include a plurality of visual features.

8. The method of claim 1, wherein the analyzing of video segment further comprises using face detection to identify subjects.

9. The method of claim 1, wherein the processor is connected to a display device and the method further comprises:
receiving a request for a portion of the video;
matching the request to the category and characteristics associated with the video;
displaying the portion of the video matching the request.

10. An adaptive environment system, comprising:
a processing system connectable to a network, the network comprising one or more interconnected sensors, the processing system comprising a computer readable medium comprising computer code for instructing one or more processors to:
a. receive recorded data from the one or more sensors connectable to the processing system;
b. analyze the recorded data to identify an event occurring in the recorded data;
c. determine whether a response to the identified event is appropriate; and
d. when a response is appropriate generate a signal associated with the response.

11. The system of claim 10, further comprising a storage device communicatively connected to the processing system and further comprising computer code for instructing the one or more processors to:
de-mix the recorded data into at least a video segment and an audio segment;
perform a probabilistic analysis of the video and audio; and
calculate a probability of the recorded data falling within a category.

12. The system of claim 11, wherein the recorded data is archived in the storage device.

13. The system of claim 10, wherein the computer code comprises a probabilistic engine for analyzing the recorded data.

14. The system of claim 13, wherein the probabilistic engine uses a Bayesian approach.

15. The system of claim 10, wherein when the event identified is a dangerous event, the response is to notify a designated person.

16. The system of claim 10, wherein when the event identified is an energy saving event, the response is to control an appliance interconnected to the network.

17. The system of claim 10, wherein the event identified is a suggestion event and the response is to transmit a message to a user.

18. The system of claim 10, further comprising computer code for instructing the one or more processors to:
create an index of the recorded data;
store the index in an index file; and
store the recorded data along with the index file on a storage device.

19. The system of claim 18, wherein processing system is created to receive a search request from a user and further comprising computer code for instructing the one or more processors to:
match a parameter of the search request to a portion of the index file; and
return a portion of the recorded data corresponding to the section of the index file matching the parameter of the search request.

20. The system of claim 10, wherein the processing system is programmed to analyze an identity of a recorded subject and perform an action if the recorded subject is unrecognized.

21. The system of claim 20, wherein the action is setting off an alarm.

22. The system of claim 20, wherein the action is notifying law enforcement authorities.

23. The system of claim 20, wherein the action is notifying a designated person.

24. A method of classifying and indexing events recorded in an operating environment, the method comprising:
communicatively connecting a recording device to a processor and a storage device;
storing a group of categories in the processor, each of the categories being associated with pre-defined characteristics;
positioning at least the recording device in the operating environment;
recording a video file associated with an event using the recording device;
de-multiplexing the video file into at least three streams of data, each of the streams of data being associated with a respective set of characteristics;
comparing the set of characteristics of each of the streams of data with the predefined characteristics stored in the processor to determine a category for the video file;
creating an index file having the category and other data associated with the video file stored therein; and
storing the video file along with the index file in the storage device so as to be retrievable by a user.

25. A system for classifying and indexing events recorded in an operating environment, comprising:
at least one recording device positioned in the operating environment for recording a video file associated with an event;
a processor communicatively connected to the recording device, the processor storing a group of categories each being associated with pre-defined characteristics and the processor programmed to:
de-mix the video file into at least three streams of data, each of the streams of data being associated with a respective set of characteristics;
compare the set of characteristics of each of the streams of data with the pre-defined characteristics stored in the processor to determine a category for the video file;
create an index file having the category and other data associated with the video file stored therein; and
a storage device communicatively connected to the processor for storing the video file along with the index file so as to be retrievable by a user.

26. The system of claim 25, wherein there are at least three recording devices communicatively connected to the processor.
